(19) United States
(12) Patent Application Publication
(10) Pub. No.: US 2013/0050621 A1
(43) Pub. Date: Feb. 28, 2013

(54) LIQUID CRYSTAL DISPLAY PANEL AND DISPLAY APPARATUS USING THE SAME

(71) Applicant: Chihtsung Kang, Shenzhen (CN)

(72) Inventor: Chihtsung Kang, Shenzhen (CN)

(73) Assignee: SHENZHEN CHINA STAR OPTOELECTRONICS TECHNOLOGY CO., LTD., Shenzhen (CN)

(21) Appl. No.: 13/264,879

(22) PCT Filed: Aug. 31, 2011
(86) PCT No.: PCT/CN11/79130

§ 371 Date: Oct. 17, 2011

(30) Foreign Application Priority Data
Aug. 29, 2011 (CN) 201110251070.0

(51) Int. Cl. G02F 1/1337

(52) U.S. Cl. 349/123

(57) ABSTRACT

The present invention provides a liquid crystal display panel and a display apparatus using the same. The liquid crystal display panel comprises a first substrate, a second substrate and a liquid crystal layer. The liquid crystal layer is formed between the first substrate and the second substrate. The second substrate comprises a second electrode. The second electrode comprises a plurality of elongated electrode elements, and the elongated electrode elements have different extending angles. The liquid crystal display panel is applicable to the display apparatus. The invention can improve the color shift problem of the liquid crystal display panel.

### FIELD OF THE INVENTION

The present invention relates to a field of a liquid crystal display technology, and more particularly to a liquid crystal display (LCD) panel and a display apparatus using the same.

### BACKGROUND OF THE INVENTION

Liquid crystal displays (LCDs) have been widely applied in electrical products. Currently, most of LCDs are backlight type LCDs which comprise a liquid crystal panel and a backlight module. The liquid crystal panel is composed of two transparent substrates and a liquid crystal sealed there-between. In particular, a liquid crystal panel of a polymer stabilized vertical alignment (PSVA) type which is made using a polymer-stabilized alignment (PSA) process, can have some advantages, such as wide viewing angle, high aperture ratio, high contrast and simple process.

In the PSVA type LCD, reactive monomers can be doped in the liquid crystal between the two transparent substrates and mixed with liquid crystal molecules, wherein the a polyimide (PI) is coated on the surface of each of the transparent substrates to be an alignment layer. Subsequently, when applying a voltage and irradiating an ultraviolet (UV) light to the two transparent substrates, a phase separation arises in the reactive monomers and the liquid crystal molecules, and a polymer is formed on the alignment layer of the transparent substrate. The liquid crystal molecules are oriented along a direction of the polymer due to the interaction between the polymer and the liquid crystal molecules. Therefore, the liquid crystal molecules between the transparent substrates can have a pre-tile angle.

However, currently, a color shift problem is likely to occur in the VA type LCD, hence deteriorating the display quality of the LCD.

As a result, it is necessary to provide an LCD panel and a display apparatus using the same to solve the problems existing in the conventional technologies, as described above.

### SUMMARY OF THE INVENTION

The present invention provides an LCD panel and a display apparatus using the same to solve the color shift problem of the VA type LCD.

A primary object of the present invention is to provide a liquid crystal display panel, and the liquid crystal display panel comprises: a first substrate comprising a first electrode and a first alignment layer, wherein the first alignment layer is formed on the first electrode; a second substrate comprising a second electrode and a second alignment layer, wherein the second alignment layer is formed on the second electrode; and a liquid crystal layer formed between the first substrate and the second substrate; wherein the second electrode comprises a plurality of elongated electrode elements, and the elongated electrode elements have different extending angles.

Another object of the present invention is to provide a display apparatus, and the display apparatus comprises a backlight module and the above-mentioned liquid crystal display panel.

A further object of the present invention is to provide a liquid crystal display panel, and the liquid crystal display panel comprises: a first substrate comprising a first electrode and a first alignment layer, wherein the first alignment layer is formed on the first electrode; a second substrate comprising a second electrode and a second alignment layer, wherein the second alignment layer is formed on the second electrode; and a liquid crystal layer formed between the first substrate and the second substrate; wherein the second electrode comprises a plurality of elongated electrode elements, and the elongated electrode elements have different extending angles, and the extending angles of the elongated electrode elements are in the range of 40 degrees to 45 degrees, and the elongated electrode elements have at least two different arrangement pitches.

In one embodiment of the present invention, the extending angles of the elongated electrode elements are in the range of 40 degrees to 45 degrees.

In one embodiment of the present invention, the liquid crystal display panel has a plurality of pixel regions, and the second electrode in each of the pixel regions includes a main pixel electrode pattern and a plurality of elongated electrode elements, and the elongated electrode elements obliquely extend from the main pixel electrode pattern and are arranged parallel to each other.

In one embodiment of the present invention, each of the elongated electrode elements is composed of a plurality of straight line patterns.

In one embodiment of the present invention, the elongated electrode elements are curve patterns.

In one embodiment of the present invention, the elongated electrode elements have at least two different arrangement pitches.

In one embodiment of the present invention, the different arrangement pitches include a first arrangement pitch and a second arrangement pitch, and the first arrangement pitch and the second arrangement pitch are formed between the elongated electrode elements in an alternating manner.

In one embodiment of the present invention, the first arrangement pitch is 7 μm, and the second arrangement pitch is 6 μm.

In one embodiment of the present invention, wherein the elongated electrode elements have three or more than three different arrangement pitches which are sequentially formed between the elongated electrode elements.

The LCD panel and the display apparatus using the same of the present invention can improve the color shift problem of the LCD panel by adjusting the extending angles of the elongated electrode elements, thereby enhancing the display quality of the display apparatus.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a cross-sectional view showing a liquid crystal display panel according to a first embodiment of the present invention;

FIG. 2 is a schematic diagram showing a pixel region of the liquid crystal display panel according to the first embodiment of the present invention;

FIG. 3 is a schematic diagram showing a sub-pixel region of the liquid crystal display panel according to the first embodiment of the present invention;

FIG. 4 is a voltage (V)-transmittance (T) graph of a pixel according to the first embodiment of the present invention;

FIG. 5 is a schematic diagram showing a pixel region of the liquid crystal display panel according to a second embodiment of the present invention; and

FIG. 6 is a schematic diagram showing a pixel region of the liquid crystal display panel according to a third embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

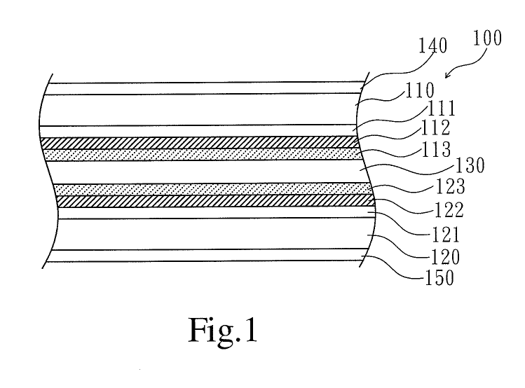

Referring to FIG. 1, a cross-sectional view showing a liquid crystal display (LCD) panel according to a first embodiment of the present invention is illustrated. The display apparatus of the present embodiment can comprises the liquid crystal display panel 100 and a backlight module (not shown). The liquid crystal display panel 100 is disposed opposite to the backlight module, and the backlight module may be realized as a side lighting backlight module or a bottom lighting backlight module to provide the liquid crystal display panel 100 with the back-light.

Referring to FIG. 1 again, the liquid crystal display panel 100 of the present embodiment may comprise a first substrate 110, a second substrate 120, a liquid crystal layer 130, a first polarizer 140 and a second polarizer 150. The first substrate 110 and the second substrate 120 may be realized as glass substrates or flexible plastic substrates. In this embodiment, the first substrate 110 may be a glass substrate or other material substrate with color filters (CF), and the second substrate 120 may be a glass substrate or other material substrate with a thin film transistor (TFT) array. It notes that the CF and the TFT array may also be disposed on the same substrate in other embodiments.

Referring to FIG. 1 again, the liquid crystal layer 130 is formed between the first substrate 110 and the second substrate 120 and includes reactive monomers and liquid crystal molecules. The reactive monomers are preferably photo-sensitive monomers mixed with the liquid crystal molecules. The first polarizer 140 is disposed on one side of the first substrate 110 and opposite to the liquid crystal layer 130 (i.e. a light-emitting side of the first substrate 110). The second polarizer 150 is disposed on one side of the second substrate 120 and opposite to the liquid crystal layer 130 (i.e. a light-incident side of the second substrate 120).

Referring to FIG. 1 again, in this embodiment, the first substrate 110 can comprise a first electrode 111, a first alignment layer 112 and a first polymer alignment layer 113. The first alignment layer 112 and the first polymer alignment layer 113 are formed on the first electrode 111 in sequence. The second substrate 120 can comprise a second electrode 121, a second alignment layer 122 and a second polymer alignment layer 123. The second alignment layer 122 and the second polymer alignment layer 123 are formed on the second electrode 121 in sequence. The first electrode 111 and the second electrode 121 are preferably made of a transparent and electrically conductive material, such as ITO, IZO, AZO, GZO, TCO or ZnO. A voltage can be applied to the liquid crystal molecules of the liquid crystal layer 130 by the first electrode 111 and the second electrode 121. In this embodiment, the first electrode 111 may be a common electrode, and the second electrode 121 may be a pixel electrode. In addition, the second electrode 121 can have a plurality of regions, and the voltage applied to each of the regions may be the same or different. The alignment layers 112, 122 and the polymer alignment layers 113, 123 can have an alignment direction for determining the orientation of the liquid crystal molecules of the liquid crystal layer 130. The alignment layers 112, 122 and the polymer alignment layers 113, 123 can have a pre-tile angle, wherein the pre-tile angle is less than 90 degrees, preferably less than 60 degrees. Preferably, the alignment layers 112, 122 are made of a dielectric material on the substrates 110, 120 using a sputtering technique. The material of the alignment layers 112, 122 is preferably a dielectric and inorganic material, such as silicon dioxide (SiO₂). The polymer alignment layers 113, 123 are polymerized of the reactive monomers bonded with the alignment layers 112, 122.

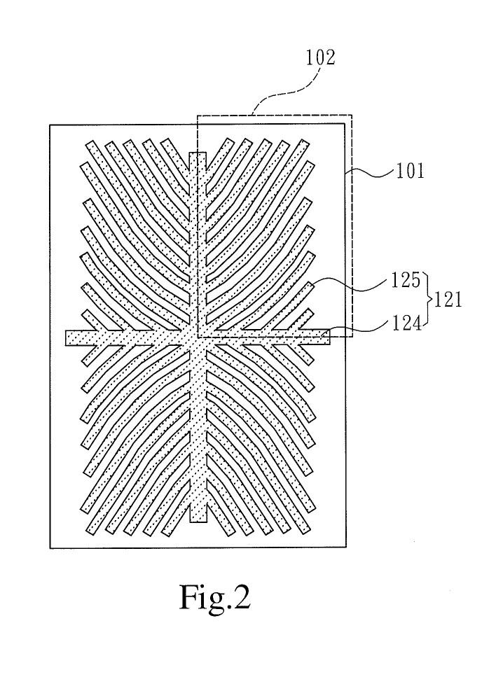

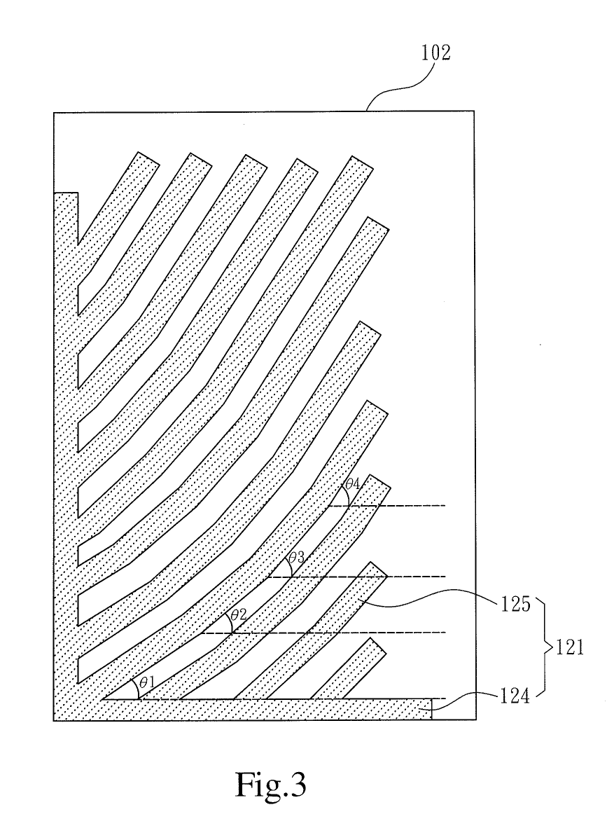

Referring to FIG. 2 and FIG. 3, FIG. 2 is a schematic diagram showing a pixel region of the liquid crystal display panel according to the first embodiment of the present invention, and FIG. 3 is a schematic diagram showing a sub-pixel region of the liquid crystal display panel according to the first embodiment of the present invention. The second substrate 120 comprises a plurality of signal lines (not shown), such as gate lines and data lines, which are crisscrossed, and thereby form a plurality of pixel regions 101 arranged in an array. In each of the pixel regions 101, the second electrode 121 has a pixel pattern for forming a multi-domain alignment. In this embodiment, the second electrode 121 in each of the pixel regions 101 comprises a main pixel electrode pattern 124 and a plurality of elongated electrode elements 125. The main pixel electrode pattern 124 may be a crisscross pattern, and each of the pixel regions 101 is divided into four sub-pixel regions 102 by the main pixel electrode pattern 124. In each of the sub-pixel regions 102, the elongated electrode elements 125 obliquely extend from the main pixel electrode pattern 124 and are arranged parallel to each other. In this case, the elongated electrode elements 125 have different extending angles, i.e. there are a plurality of angles θ1, θ2, θ3, θ4 between a single elongated electrode element 125 and the main pixel electrode pattern 124 (or a horizontal direction). Preferably, the extending angles of the elongated electrode elements 125 are in the range of 40 degrees to 45 degrees.

In this embodiment, the single elongated electrode element 125 can be composed of a plurality of straight line patterns, so as to form the different extending angles. In another embodiment, the elongated electrode elements 125 may be curve patterns of continuously extending angles.

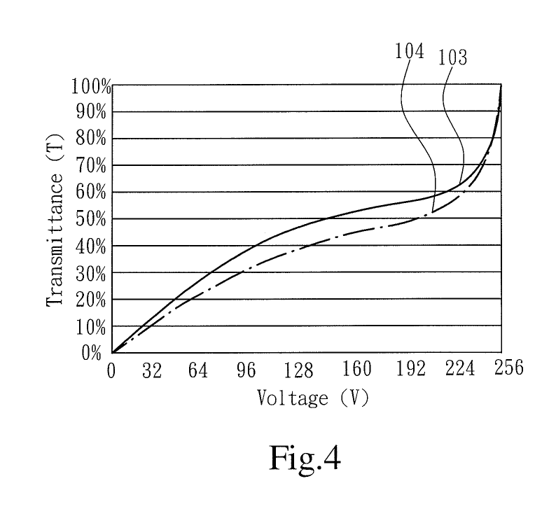

Referring to FIG. 4, a voltage (V)-transmittance (T) graph of a pixel according to the first embodiment of the present invention is illustrated. In FIG. 4, a line 103 indicates a V-T relation when the extending angle of the elongated electrode element 125 (i.e. the angle between the elongated electrode element 125 and the horizontal direction) is 45 degrees, and a line 104 indicates a V-T relation when the extending angle of the elongated electrode element 125 is 40 degrees. Referring to FIG. 4 again, when the elongated electrode elements 125 have different extending angles, a V-T performance of the pixel is also different. Therefore, by adjusting the extending angles of the elongated electrode elements 125 of the second electrode 121, the V-T performance of the pixel can be adjusted, so as to adjust a color shift performance of the LCD panel 100, hence improving the color shift problem of the LCD panel 100.

Therefore, the color shift problem in the LCD panel 100 of this embodiment can be improved by adjusting the extending angles of the elongated electrode elements 125. An additional control device (such a timing controller) for compensating color dispersion can be omitted, thereby reducing a design cost of the LCD panel 100.

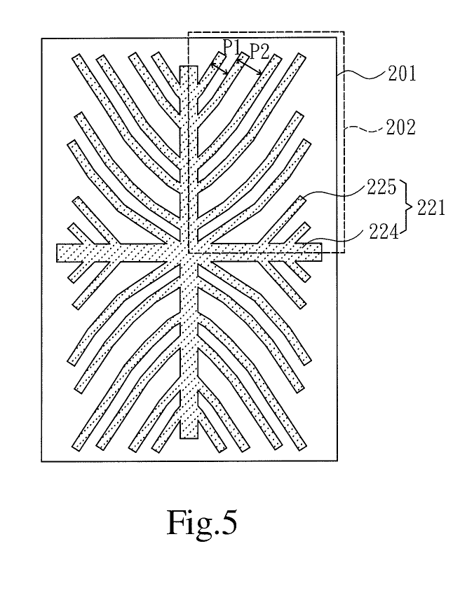

Referring to FIG. 5, a schematic diagram showing a pixel region of the liquid crystal display panel according to a second embodiment of the present invention is illustrated. Only the difference between the embodiment and the first embodiment are described hereinafter, and the similar construction therebetween is not stated in detail herein. In comparison with the first embodiment, the second electrode 221 of the second embodiment in each of the pixel regions 201 includes a main pixel electrode pattern 224 and a plurality of elongated electrode elements 225. The elongated electrode elements 225 can have different extending angles for adjust the color shift performance of the LCD panel. Furthermore, the elongated electrode elements 225 can have at least two different arrangement pitches P1, P2 therebetween. The first arrangement pitch P1 (such as 7 μm) and the second arrangement pitch P2 (such as 6 μm) are formed between the elongated electrode elements 225 in an alternating manner for improving the color shift problem of the LCD panel and achieving an effect of wide viewing angle and low color shift.

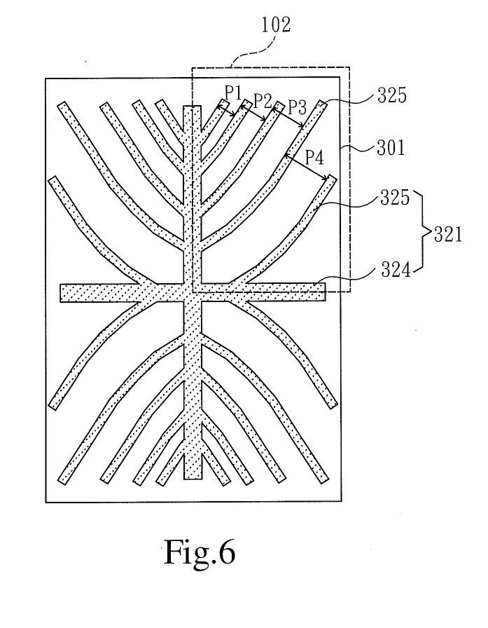

Referring to FIG. 6, a schematic diagram showing a pixel region of the liquid crystal display panel according to a third embodiment of the present invention is illustrated. Only the difference between the embodiment and the first embodiment are described hereinafter, and the similar construction therebetween is not stated in detail herein. In comparison with the first embodiment, the second electrode 321 of the third embodiment in each of the pixel regions 301 includes a main pixel electrode pattern 324 and a plurality of elongated electrode elements 325. The elongated electrode elements 325 can have different extending angles for adjust the color shift performance of the LCD panel. Moreover, the elongated electrode elements 325 can have three or more than three different arrangement pitches P1, P2, P3, P4 which are sequentially formed between the elongated electrode elements 325 in each of the sub-pixel regions 302, so as to adjust a color shift performance of the LCD panel, hence improving the color shift problem of the LCD panel.

As described above, the LCD panel and the display apparatus of the present invention using the same can improve the color shift problem of the LCD panel by adjusting the extending angles of the elongated electrode elements in a pixel electrode pattern, thereby enhancing the display quality of the display apparatus. Furthermore, an additional control device for compensating color dispersion is not necessary to the LCD panel, thereby reducing a design cost of the display.

The present invention has been described with a preferred embodiment thereof and it is understood that many changes and modifications to the described embodiment can be carried out without departing from the scope and the spirit of the invention that is intended to be limited only by the appended claims.

1. A liquid crystal display panel comprising:
a first substrate comprising a first electrode and a first alignment layer, wherein the first alignment layer is formed on the first electrode;
a second substrate comprising a second electrode and a second alignment layer, wherein the second alignment layer is formed on the second electrode; and
a liquid crystal layer formed between the first substrate and the second substrate;
wherein the second electrode comprises a plurality of elongated electrode elements, and the elongated electrode elements have different extending angles, and the extending angles of the elongated electrode elements are in the range of 40 degrees to 45 degrees, and the elongated electrode elements have at least two different arrangement pitches.

2. A liquid crystal display panel comprising:
a first substrate comprising a first electrode and a first alignment layer, wherein the first alignment layer is formed on the first electrode;
a second substrate comprising a second electrode and a second alignment layer, wherein the second alignment layer is formed on the second electrode; and
a liquid crystal layer formed between the first substrate and the second substrate;
wherein the second electrode comprises a plurality of elongated electrode elements, and the elongated electrode elements have different extending angles.

3. The liquid crystal display panel according to claim 2, wherein the extending angles of the elongated electrode elements are in the range of 40 degrees to 45 degrees.

4. The liquid crystal display panel according to claim 2, wherein each of the elongated electrode elements is composed of a plurality of straight line patterns.

5. The liquid crystal display panel according to claim 2, wherein the elongated electrode elements are curve patterns.

6. The liquid crystal display panel according to claim 2, wherein the elongated electrode elements have at least two different arrangement pitches.

7. The liquid crystal display panel according to claim 6, wherein the different arrangement pitches include a first arrangement pitch and a second arrangement pitch, and the first arrangement pitch and the second arrangement pitch are formed between the elongated electrode elements in an alternating manner.

8. The liquid crystal display panel according to claim 7, wherein the first arrangement pitch is 7 μm, and the second arrangement pitch is 6 μm.

9. The liquid crystal display panel according to claim 6, wherein the elongated electrode elements have three or more than three different arrangement pitches which are sequentially formed between the elongated electrode elements.

10. The liquid crystal display panel according to claim 2, wherein the liquid crystal display panel has a plurality of pixel regions, and the second electrode in each of the pixel regions includes a main pixel electrode pattern and a plurality of elongated electrode elements, and the elongated electrode elements obliquely extend from the main pixel electrode pattern and are arranged parallel to each other.

11. A display apparatus comprising:
a backlight module; and
a liquid crystal display panel comprising:
a first substrate comprising a first electrode and a first alignment layer, wherein the first alignment layer is formed on the first electrode;
a second substrate comprising a second electrode and a second alignment layer, wherein the second alignment layer is formed on the second electrode; and
a liquid crystal layer formed between the first substrate and the second substrate;
wherein the second electrode comprises a plurality of elongated electrode elements, and the elongated electrode elements have different extending angles.

12. The display apparatus according to claim 11, wherein the extending angles of the elongated electrode elements are in the range of 40 degrees to 45 degrees.

13. The display apparatus according to claim 11, wherein each of the elongated electrode elements is composed of a plurality of straight line patterns.

14. The display apparatus according to claim 11, wherein the elongated electrode elements are curve patterns.

15. The display apparatus according to claim 11, wherein the elongated electrode elements have at least two different arrangement pitches.

16. The display apparatus according to claim 15, wherein the different arrangement pitches include a first arrangement pitch and a second arrangement pitch, and the first arrangement pitch and the second arrangement pitch are formed between the elongated electrode elements in an alternating manner.

17. The display apparatus according to claim 16, wherein the first arrangement pitch is 7 μm, and the second arrangement pitch is 6 μm.

18. The display apparatus according to claim 15, wherein the elongated electrode elements have three or more than three different arrangement pitches which are sequentially formed between the elongated electrode elements.

19. The display apparatus according to claim 11, wherein the liquid crystal display panel has a plurality of pixel regions, and the second electrode in each of the pixel regions includes a main pixel electrode pattern and a plurality of elongated electrode elements, and the elongated electrode elements obliquely extend from the main pixel electrode pattern and are arranged parallel to each other.
